(19) United States
(12) Patent Application Publication
(10) Pub. No.: US 2021/0306158 A1
(43) Pub. Date: Sep. 30, 2021

(54) CERTIFICATION SYSTEM AND CERTIFICATION METHOD FOR CERTIFYING THE EXISTENCE OF A DIGITIAL CONTENT

(71) Applicant: CRIO SOLUTIONS S.R.L., Torino (IT)

(72) Inventors: Daniele OCCHETTI, Torino (IT); Francesco BRUSCHI, Torino (IT); Vincenzo RANA, Torino (IT)

(21) Appl. No.: 17/267,165

(22) PCT Filed: Aug. 13, 2019
(86) PCT No.: PCT/IB2019/056870

§ 371 Date: Feb. 9, 2021

(30) Foreign Application Priority Data
Aug. 14, 2018 (IT) 102018000008095
Mar. 21, 2019 (IT) 102019000004151

(51) Int. Cl. H04L 9/32; H04L 12/24

(52) U.S. Cl. CPC H04L 9/3263; H04L 9/3297; H04L 2209/38; H04L 41/22; H04L 9/3239

(57) ABSTRACT

A certification system for certifying existence of digital content or “resource”, in particular available on the Internet network or usable through the network, is provided. The system has a certification platform, which is arranged for generating a certification pack, and a distributed database, to which the certification pack and/or an identification element associated therewith is/are transmitted. The certification platform comprises at least a management application for identifying and classifying the digital content, one or more collection applications for acquiring the digital content, and a certification protocol, which, for each collection application, comprises a corresponding set of certification procedures, each of which generates a certification element for a corresponding step of the procedure for acquiring the digital content, so as to create the certification pack from the group of certification elements.

### TECHNICAL FIELD

The present invention relates to a system for certifying the existence of a digital content, as well as the characterizing features (localization, timing) thereof.

More particularly, the present invention relates to a system for certifying the existence of a digital content available on the Internet network or usable through the Internet network or acquired by means of electronic devices connected to the Internet network.

The present invention further relates to a method for certifying the existence of such digital content.

### BACKGROUND ART

Currently, the vast majority of information is accessible through the Internet, whether it is technical, scientific, legal or any other contents.

Such contents may be available in different forms, among which one can indicate, by way of non-limiting example, text content, audio content, images, videos, and so on.

Systems and methods for acquiring said contents from the Internet are known, even in association with the source of the content.

In the case, for example, of an Internet page containing text and/or images, one can simply think of a “screenshot” of an Internet page, which screenshot also includes—in addition to the aforementioned contents—the HTTP address of the page itself.

However, there are no known systems that make it possible to certify beyond any doubt the presence of a certain content at a certain time on the Internet.

The mere affixing of a code and/or timestamp is not sufficient to provide such certification. In the case of the “screenshot” mentioned above, the affixing of a digital signature and/or timestamp is not sufficient to certify the truthfulness of the acquisition of the content in question.

The need to certify the existence of a content available on the Internet or a transmission of contents through the Internet is felt in various sectors, particularly in the judiciary and forensics sectors.

In this context, in fact, in the step of collating evidence it is essential to be able to certify the existence of a certain content so that it can be used in judicial forums without there being doubts about its authenticity (intended as certification of its originality and its integrity, and not as authenticity of the contents of the digital content).

More generally, in all those situations in which some form of litigation is present or possible, it is essential to have a system and a method that allow to certify the existence of a certain content as well as its originality and integrity.

The main object of the present invention is therefore to fill the gap existing in the known art by providing a tool that allows to certify the existence of a digital content existing on the Internet or in any case accessible or usable therethrough.

Another object of the present invention is to provide a tool for certifying the existence of such a digital content that is versatile and can be applied to contents of different nature. These and other objects are achieved by a system and a method for certifying the existence of digital contents as claimed in the appended claims.

### SUMMARY OF INVENTION

In its more general lines, the system according to the invention for the certification of a digital content (“resource”) includes a certification platform arranged for generating a certification pack which is uniquely associated with said resource, and a distributed database to which said certification pack and/or an identification element uniquely associated therewith is/are transmitted.

According to the invention, the aforesaid certification platform comprises:
a user interface through which the user specifies the resource to be certified;
a management application which is capable of analyzing the resource to be certified in order to identify the type and main features thereof;
at least one collection application, which is arranged to acquire the resource to be certified;
a certification protocol, which comprises at least a first set of certification procedures; wherein the collection application acquires the resource to be analyzed through an acquisition procedure consisting in a sequence of steps, and at each step it interrogates the certification protocol, and wherein at each step the certification protocol launches a corresponding certification procedure among said set of certification procedures, said certification procedure controlling the correct running of the corresponding step and guaranteeing the authenticity thereof, and generating a corresponding certification element. At the end of the process in which the collection application acquires the resource, the certification protocol will thus have generated a certification pack consisting of the set of certification elements generated by the certification procedures of the set of certification procedures.

The certification protocol may possibly generate one or more identification elements, uniquely associated with the certification pack and consequently with the resource.

The certification pack thus obtained or, preferably, an identification element associated with said certification pack is transmitted to the distributed database.

This identification element can, for example, contain all the information to be identified as a HASH.

This distributed database can be, for example, a distributed database of the blockchain type. Preferably, the platform of the system according to the invention further comprises a memory unit, in which the certification packs generated by the certification protocol can be stored, possibly together with their corresponding identification elements.

Said memory unit can be, for example, a remote system of the cloud type.

In a preferred embodiment, the set of certification procedures of the certification protocol comprises at least:
a procedure relating to the source requesting certification of the existence of the resource;
a procedure relating to the target, i.e. to the recipient having the resource;
a procedure relating to the sequence of operations required for acquiring the resource;
a procedure relating to the data traffic exchanged during acquisition of the resource;
a procedure relating to the content of the resource, i.e. to the state and characterizing features thereof.

From the above, it will be evident to the person skilled in the art that the system according to the invention, and in particular the certification protocol of said system, allows to generate a certification pack formed by a plurality of certification elements, each uniquely correlated to a corresponding step of the acquisition of the resource to be certified.

In other words, the system according to the invention provides a certification pack relating to a resource and to the process of acquiring said resource, in which the starting point, the arrival point and each step of the path followed from the starting point to the arrival point for acquiring said resource are individually certified, thus excluding circumstances of alteration, tampering, manipulation, falsification, sabotage, interception or diversion.

In a preferred embodiment of the invention, the certification platform comprises a plurality of collection applications and the certification protocol correspondingly comprises a plurality of sets of certification procedures, each collection application being associated with a specific set of certification procedures including the certification procedures suitable for certifying the steps performed by said collection application.

In this preferred embodiment, the platform management application is capable of preliminarily analyzing the features of the resource and selecting, among the plurality of collection applications, the most appropriate collection application according to the resource to be certified.

Advantageously, the presence of a plurality of different collection applications allows to expand the type of certifiable resources, in terms of representation mode, digital content and/or container.

The invention further relates to a method for certifying the existence of a resource, said method comprising the steps of:
identifying the resource to be certified;
generating a certification pack, which is uniquely associated with said resource, and possibly one or more identification elements which are uniquely associated with said certification pack;
transmitting said certification pack, or possibly said identification element associated therewith, to a database of the distributed type, wherein said certification pack, or possibly said identification element associated therewith, is stored for being notarized and therefore associated with a timestamp;
   wherein said step of generating said certification pack comprises the steps of:
identifying a sequence of steps required for acquiring said resource;
iteratively interrogating a certification protocol for generating a certification element for each of said steps;
   said certification pack thus consisting of the set of said certification elements.

Preferably, the method according to the invention further comprises a step of storing the certification pack, for example in a remote system of the cloud type.

The system and method according to the invention allow certification of the existence of digital contents (“resources”) present in the Internet, but also of resource that are arranged for being usable in the Internet, or are acquired by means of electronic devices connectable to the Internet.

In the latter case, the method according to the invention will also provide for a preliminary step of inputting the resource into the Internet network.

### BRIEF DESCRIPTION OF DRAWINGS

Other features and advantages of the present invention will be more apparent from the ensuing description of a preferred embodiment of the invention, provided merely by way of non-limiting example with reference to the annexed drawings, in which:

FIG. 1 is a schematic representation, in the form of a block diagram, of the certification system according to the invention;

FIG. 2 is a schematic representation, in the form of a block diagram, of the certification platform of the certification system according to the invention.

### DESCRIPTION OF EMBODIMENTS

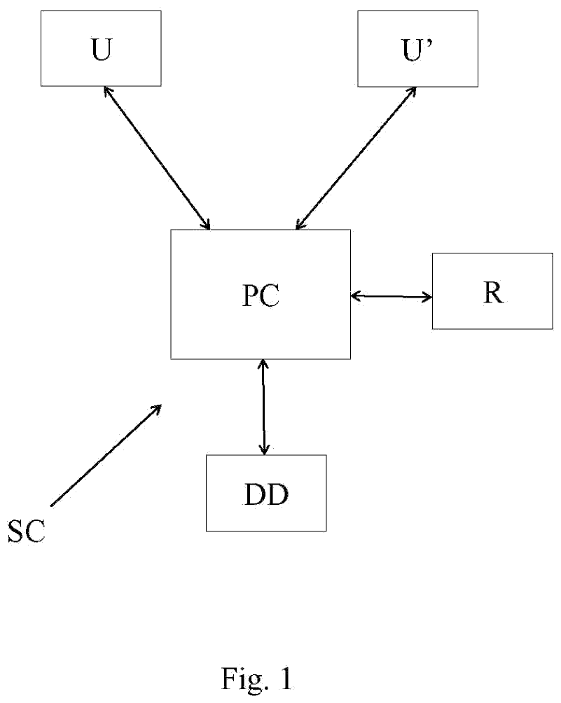

Referring at first to FIG. 1, the certification system SC according to the invention is schematically illustrated in its most general lines.

Said certification system essentially comprises a certification platform PC capable of creating a certification pack uniquely associated with a resource R (i.e. a digital content located in the Internet or usable therethrough) the existence of which a user U wishes to certify.

Preferably, the certification platform PC generates, besides the certification pack, at least one identification element uniquely associated with said certification pack.

Said identification element can be a code identifying the certification pack and/or a certification report.

The advantage of generating said identification element is that this can be more concise, and consequently more easily usable, than the certification pack in its entirety.

For example, an identification code takes up far less space than the certification pack when it is to be transmitted or stored.

This identification code can be, for example, a HASH or a blockchain token.

Similarly, a certification report takes up less space than the certification pack when it is to be transmitted or stored and can be provided in a format that can be easily viewed and/or printed on paper.

The certification system SC according to the invention includes a distributed database DD to which the certification platform transmits the aforementioned certification pack and/or the aforementioned identification element of said certification pack.

The function of the distributed database DD is to provide a guarantee of authenticity and integrity of the certification pack, i.e. a guarantee of notarization (history logging and verifiability by third parties) of the result of the process of certification of the existence of the resource R (i.e. of the certification pack).

For this purpose, once the certification platform transmits the certification pack and/or the identification element of said certification pack to the distributed database, said distributed database returns a unique transaction identifier (TXID—Transaction ID) which represents a unique receipt of the taking in charge by the distributed database.

The distributed database can be, for example, a distributed database of the blockchain type. Since blockchain-type databases are not suitable for handling very heavy IT contents, the advantage of generating a “lighter” identification element uniquely associated with the certification pack is clear.

For this reason, in the preferred embodiment of the invention, the certification platform PC also generates an identification code as an identification element uniquely associated with the certification pack, and only this identification code is sent to the distributed database DD.

Therefore, the user U who wishes to certify the existence of a resource R accesses the certification platform PC.

According to the preferred embodiment illustrated, said certification platform PC generates a certification pack uniquely associated with the resource R, as well as an identification code and a certification report uniquely associated with said certification pack.

The certification platform PC makes available to the user U the generated certification pack, as well as the identification code and the certification report associated therewith, and transmits said identification code to the distributed database DD.

In the event that a second user U′ subsequently contests the existence of the resource or wants to verify its authenticity, said second user U′ may be provided with the identification code of the previously generated certification pack and a transaction identification code (TXID).

The second user U′ will thus be able to access, with said codes (identification code of the certification pack and identification code of the transaction), the certification platform PC and, through said platform, the distributed database DD and verify the correctness of the identification code of the certification pack, corresponding to the transaction identified by the unique transaction identification code, thus obtaining a confirmation of the correct certification of the resource R

According to the invention, the certification platform PC is structured in such a way as to generate the certification pack through an iterative process of obtaining certification elements, each relating to a single step necessary for the acquisition of the resource R to be certified.

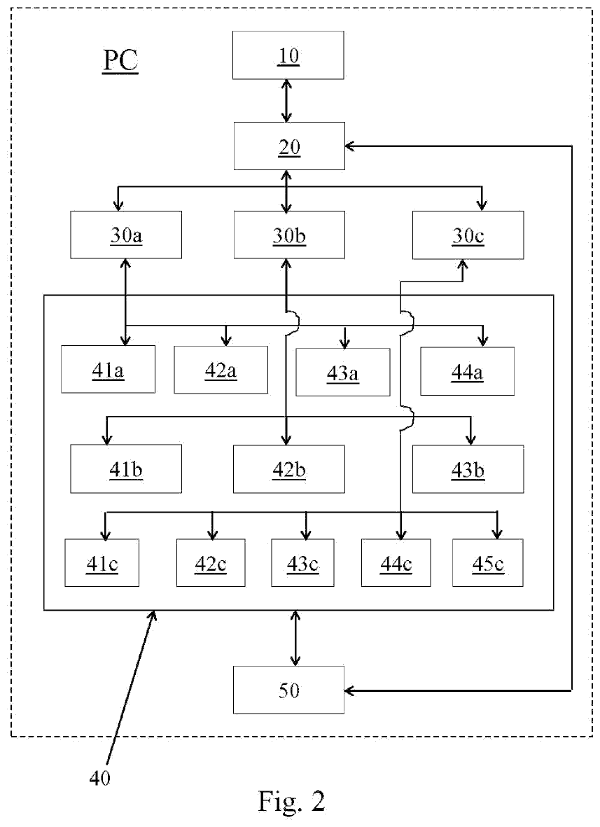

This structure of the certification platform PC is schematically illustrated in FIG. 2.

The certification platform PC includes a user interface 10 through which the user U can interact with the certification platform.

Said user interface will belong to the certification platform PC and will be independent of the IT platform employed by the user.

In particular, initially the user U can use the user interface 10 to create his/her own profile and obtain the related credentials. Subsequently, the user U will be able to use the user interface 10 to insert into the certification platform the resource R to be certified and to download from the certification platform the corresponding certification pack, as well as the identification elements (identification code, certification report) associated therewith. In the event that the generation of the certification pack is subject to a cost, the user U may also use the user interface 10 to carry out the payment transactions.

Similarly, the second user U′ who wishes to verify the authenticity of a resource may use the user interface to enter the identification code associated with the certification pack and obtain confirmation of the certification of the resource R.

The certification platform PC further includes a management application 20.

The management application 20 is capable of analyzing the resource R to be certified and classifying it according to the type thereof.

The management application 20 is also configured to instruct a collection application to acquire the R resource to be certified.

In particular, in the preferred embodiment shown in FIG. 2, the certification platform comprises three different collection applications 30a, 30b, 30c and the management application 20 is capable of selecting one of these collection applications depending on the type of resource to be certified.

By way of non-limiting example, the collection applications 30a, 30b, 30c may comprise:
a remote browser for the acquisition of dynamic resources and browsing sessions, in particular a remote browser executed in a guaranteed environment in which the browser execution process cannot be altered or tampered with by the user or disturbed by other processes (for example, TRUSTED platforms);
a batch download device for the acquisition of massive groups of resources, such as the entire content of a website;
a spider system for searching the Internet for resources that share the same characteristics (for example, searches by keyword, searches by image, and the like);
a polling system for the cyclic verification of a dynamic resource and the periodic acquisition of its changes;
an app for the acquisition of resources produced by mobile devices such as smartphones, tablets and the like;
a system of receivers for the acquisition of resources from sources external to the Internet, such as TOT actuators and sensors, electronic archives, chats and live video communications and the like.

As mentioned above, the management application 20—based on the information entered in the user interface by the user—will select the most appropriate collection application, which will start the acquisition process of the resource R to be certified.

This acquisition process is divided into a sequence of steps.

According to the invention, the certification platform comprises a certification protocol 40 which comprises at least a set of certification procedures, and comprises in particular a plurality of sets of certification procedures A, B, C, as many as the collection applications 30a, 30b, 30c.

A set of certification procedures A, B, C is uniquely associated to each collection application 30a, 30b, 30c.

During the resource acquisition process, the collection application 30a, 30b, 30c iteratively interrogates the certification protocol 40: for each step of the acquisition process, said certification protocol executes the corresponding certification procedure, which generates a corresponding certification element.

At the end of the resource acquisition procedure, the certification protocol will have generated a certification pack that will consist of a set of certification elements, as many as the certification procedures launched by the certification protocol.

As schematically illustrated in FIG. 2, sets of certification procedures differing in number and type of the procedure contained therein correspond to different collection applications 30a, 30b, 30c.

By way of example:
in the case of the collection device 30a (for example a remote browser), the process of acquiring the resource will be divided into four steps and, accordingly, at each step the certification protocol will launch the certification procedures 41a, 42a, 43a, 44a; the certification pack will therefore include four different certification elements;
in the case of the collection device 30b (for example a spider system), the process of acquiring the resource will be divided into three steps and, accordingly, at each step the certification protocol will launch the certification procedures 41b, 42b, 43b; the certification pack will therefore include three different certification elements;
in the case of the collection device 30c (for example an app for mobile devices), the process of acquiring the resource will be divided into five steps and, accordingly, at each step the certification protocol will launch the certification procedures 41c, 42c, 43c, 44c, 45c; the certification pack will therefore include five different certification elements.

It will be evident to the person skilled in the art that the number of passages, and consequently of certification procedures, has been limited here to avoid overloading the present description: in practice, the division of the acquisition process in a sequence of steps can be much finer and the number of certification procedures consequently much higher, so that the certification pack will be more complex.

It will also be evident to the person skilled in the art that the system according to the invention provides a certification pack relating to a resource and to its acquisition process in which the starting point, the arrival point and each step of the path followed from the starting point to the arrival point to acquire this resource are individually certified.

In this regard, the sets of certification procedures A, B, C can advantageously comprise:
a procedure for certifying the source requesting certification of the existence of the resource, said procedure being capable of generating a certification element providing a positive identification of the source;
   a procedure for certifying the recipient having the resource to be certified, said procedure being capable of generating a certification element providing a positive identification of the target (for example by means of TLSNOtary techniques and technologies);
a procedure for certifying events, said procedure recording all the activities, events and commands occurring during the certification procedure, at all levels and for all functional and operational components, and generating one or more corresponding certification elements;
a procedure for certifying data traffic, said procedure recording the data traffic exchanged during the resource acquisition process, and generating a corresponding certification element (for example by means of trusted/verifiable computing techniques for guaranteed execution of software);
a procedure for certifying the resource, said procedure recording the resource being certified (together with its state and characterizing features), in atomic or aggregated forms, individually or as a whole, irrespective of the representation modes, the digital content or container, and generating one or more corresponding certification elements (for example, in the form of HASH of the resource);
a procedure for certifying references, said procedure acquiring all the references that have contributed to the access to the resource being acquired and generating one or more corresponding certification elements;
a procedure for certifying recordings, said procedure being capable of acquiring snapshots and videos of the resource being acquired as well as of the session required to achieve it, and issuing corresponding certification elements;
a temporal certification procedure, said procedure being capable of issuing one or more elements of certification of temporal information (for example timestamps) associated with all the above mentioned procedures;
a procedure for certifying execution, said procedure allowing to guarantee the correct and complete execution of a software procedure (source code) and not of any other ones (altered or tampered with), and procedures that allow you to be certain that only certified components of the platform can invoke others components;
a procedure for certifying the connections between components, said procedure ensuring that only certified components of the platform can invoke other components.

At the end of the execution of the aforementioned certification procedures, the certification protocol 40 will have generated a digital certification pack.

Said certification pack may for example be in the form of a compressed electronic archive, an encrypted archive and/or an archive digitally signed with key mechanisms or digital certificates.

It is evident that the certification pack generated by the system according to the invention is complex, and the finer the division into steps of the procedure for acquiring the resource to be certified gets, the more complex said pack becomes.

Advantageously, in the preferred embodiment described, the certification pack is also capable of generating an identification code, which is uniquely associated with the certification pack and/or a certification report containing all the information of the certification pack in a format that can be easily viewed and/or printed on paper.

The certification report is intended for the user U who requested the certification of the resource, who will be able to access this report through the user interface 10 of the certification platform PC.

The identification code uniquely associated with the certification pack, too, is made available to the user U.

It is also transmitted to the distributed database DD for guaranteeing the authenticity of the data contained in the certification pack (and consequently of the resource R) and for a subsequent verification in the event of interrogation by a second user U′ that disputes the authenticity of the resource.

In order to provide this guarantee, the distributed database DD returns a unique transaction identifier (TXID—Transaction ID), which represents a unique receipt for the distributed database itself.

The certification platform PC further comprises a memory unit 50 to which the certification pack—possibly together with the identification elements associated therewith—is transmitted and in which the certification pack is stored.

Said memory unit allows both a definitive long-term storage of a complete certification pack, and a temporary storage of a certification pack that requires subsequent processing (for example in the case in which the collection application is a polling system or an application for mobile devices, such as smartphones and tablets).

Said memory unit can consist, for example, of a remote system of the cloud type. According to the above description, the method according to the described embodiment is carried out as follows:
the user U connects to the certification platform PC and, through the interface 10, specifies the resource R to be certified;
the management application 20 identifies the resource to be certified and classifies it on the base of its type;
the management application 20 selects the collection application 30a, 30b, 30c most suitable to acquire the resource R on the basis of its type;
the collection application starts the procedure for acquiring the resource R;
at each single step of the certification procedure, the collection application interrogates the certification protocol 40 in an iterative way;
at each interrogation, the certification protocol 40 carries out a corresponding certification procedure 41a-44a, 41b-43b, 41c-45c;
each certification procedure generates one or more corresponding certification elements;
the certification protocol 40 generates a certification pack starting from the set of certification elements;
the certification protocol 40 generates a certification report and an identification code uniquely associated with the certification pack;
the certification protocol 40 transmits the certification pack, together with the certification report and the identification code, to the management application 20 for downloading by the user;
the certification protocol 40 transmits the certification pack to the memory unit 50 for archiving;
the certification protocol 40 transmits the identification code to the distributed database DD.

### EXAMPLES OF APPLICATION

### Example 1—Acquisition of Evidence

The user U is the holder of a patent that has found out that a competitor advertises on his/her Internet page a product that violates the scope of protection of the holder's patent.

The user U therefore wishes to acquire evidence of counterfeiting in a certified manner and therefore accesses the certification platform PC of the certification system SC according to the invention.

In this example, the management application 20 of the certification platform selects a remote browser 30a as a collection application.

The collection application acquires the resource through a browsing session on the Internet site of the alleged infringer.

At each step of the browsing session, the certification protocol 40 performs the corresponding certification procedures 41a-44a associated with the remote browser 30a as a collection application.

At the end of the browsing session, the certification protocol will have created a certification pack and a corresponding identification code that will be transmitted to the distributed database DD.

### Example 2—Web Watch

The user U is a stylist who has created a new dress model and wants to acquire information on how many people on the Internet are offering imitations of his/her dress on the market. The user U wants to obtain this information in a certified way to evaluate subsequent legal actions and therefore accesses the certification platform PC of the certification system SC according to the invention.

In this example, the management application 20 of the certification platform selects a spider system 30b as a collection application.

The collection application, on the basis of the image of the dress in question, starts a search on the Internet to find correspondences.

At each step of the search, the certification protocol 40 performs the corresponding certification procedures 41b-43b associated with the spider system 30b as a collection application.

At the end of the browsing session, the certification protocol will have created a certification pack and a corresponding identification code that will be transmitted to the distributed database DD.

### Example 3—Crime Scene Inspection

The user U is a forensic police officer who must carry out a crime scene inspection and must acquire images of the crime scene.

The user U wants these images to be acquired in a certified way for a subsequent trial and therefore accesses the certification platform PC of the certification system SC according to the invention.

In this example, the management application 20 of the certification platform selects a smartphone app 30c as a collection application.

The collection application acquires the resource by transmission of the images acquired by the user's smartphone camera to the Internet and subsequent certification of their existence on the Internet.

At each step of the browsing session, the certification protocol 40 performs the corresponding certification procedures 41c-45c associated with the smartphone app 30c as a collection application.

At the end of the browsing session, the certification protocol will have created a certification pack and a corresponding identification code that will be transmitted to the distributed database DD.

It will be evident to the person skilled in the art that the system and the method described above allow to achieve the aforementioned purposes, since they allow to certify the existence of digital contents providing guarantees of authenticity and integrity and excluding circumstances of alteration, tampering, manipulation, falsification, sabotage, interception or diversion.

It is understood that the embodiment described and illustrated above has been provided merely by way of example, and numerous modifications and variations within the reach of the person skilled in the art are possible without departing from the scope of protection defined by the appended claims.

1. A certification system for certifying the existence of a digital content or “resource”, which is available on the Internet network or usable through the Internet network, wherein the certification system comprises at least:
a certification platform, which is arranged for generating a certification pack, which is uniquely associated with the resource; and
a distributed database, to which the certification platform transmits the certification pack;
wherein the certification platform comprises at least:
a user interface, for inputting the resource to be certified into the certification platform and for obtaining the certification pack from the certification platform;
a management application which is capable of identifying the resource;
one or more collection applications, which are arranged to execute a procedure for acquiring the resource, the acquisition procedure being divided into a series of successive steps;
a certification protocol, which, for each of the one or more collecting applications, comprises a corresponding set of certification procedures,
the one or more collecting applications being arranged for interrogating the certification protocol at each step of the acquisition procedure, the certification protocol being arranged for executing a corresponding certification procedure of the set of certification procedures, the certification procedure being arranged for generating one or more corresponding certification elements, the certification protocol being arranged for generating a certification pack from the group of the certification elements.

2. The certification system according to claim 1, wherein the certification platform comprises a plurality of collection applications, and wherein the management application is configured for classifying the resource and for selecting one of the collecting applications according to the type of the resource.

3. The certification system according to claim 1, wherein the certification platform comprises one or more collecting applications selected from the group comprising: a remote browser; a batch download device; a spider system; a polling system; an app for mobile devices such as smartphones and tablets; a system of receivers for acquiring resources coming from sources other than the Internet network.

4. The certification system according to claim 1, wherein each of the one or more sets of certification procedures comprises one or more certification procedures selected from the group comprising: a procedure for certifying the source; a procedure for certifying the target; a procedure for certifying the events; a procedure for certifying the data traffic; a procedure for certifying the resource; a procedure for certifying the references; a procedure for certifying recording; a procedure for certifying time; a procedure for certifying execution; a procedure for certifying the connection between components.

5. (canceled)

6. The certification system according to claim 1, wherein the certification platform (PC) further comprises a memory unit, to which the certification pack is transmitted and in which the certification pack is stored.

7. The certification system according to claim 6, wherein the memory unit is a remote system of the cloud type.

8. The certification system according to claim 1, wherein the distributed database is a distributed database of the blockchain type.

9. A certification method for certifying the existence of a digital content or “resource”, which is available on the Internet network or which is usable through the Internet network, wherein the certification method comprises at least:
identifying the resource;
generating a certification pack, which is uniquely associated with the resource; and
transmitting the certification pack;
wherein generating the certification pack comprises:
executing a procedure for acquiring the resource, the acquisition procedure comprising a series of steps;
at each single step of the acquisition procedure, interrogating a certification protocol in an iterative way;
at each interrogation, executing a corresponding certification procedure contained in the certification protocol and correspondingly generating one or more corresponding certification elements; and
generating a certification pack from the group of the certification elements.

10. The certification method according to claim 9, wherein generating the certification pack comprises classifying the resource and executing a corresponding set of certification procedures selected among a plurality of sets of certification procedures according to the type of the resource.

11. The certification method according to claim 9, wherein the resource is not available on the Internet network, and wherein the method comprises the preliminary step of introducing the resource into the Internet network.

12. A certification system for certifying the existence of a digital content or “resource”, which is available on the Internet network or usable through the Internet network, wherein the certification system comprises at least:
a certification platform, which is arranged for generating a certification pack, which is uniquely associated with the resource, and one or more identification elements, which are uniquely associated with the certification pack; and
a distributed database, to which the certification platform transmits at least the identification element associated with the certification pack;
wherein the certification platform comprises at least:
a user interface, for inputting the resource to be certified into the certification platform and for obtaining at least the identification element associated with the certification pack from the certification platform;
a management application which is capable of identifying the resource;
one or more collection applications, which are arranged to execute a procedure for acquiring the resource, the acquisition procedure being divided into a series of successive steps;
a certification protocol, which, for each of the one or more collecting applications, comprises a corresponding set of certification procedures,
the collecting application being arranged for interrogating the certification protocol at each step of the acquisition procedure, the certification protocol being arranged for executing a corresponding certification procedure of the set of certification procedures, the certification procedure being arranged for generating one or more corresponding certification elements, the certification protocol being arranged for generating a certification pack and one or more identification elements which are univocally associated with the certification pack, from the group of the certification elements.

13. The certification system according to claim 12, wherein the certification platform further transmits the certification pack to the distributed database and the certification pack is further obtained from the certification platform through the user interface.

14. The certification system according to claim 12, wherein the certification platform further comprises a memory unit, to which the one or more identification elements, which are uniquely associated with the certification pack are transmitted and in which the one or more identification elements, which are uniquely associated with the certification pack are stored.

15. A certification method for certifying the existence of a digital content or “resource”, which is available on the Internet network or which is usable through the Internet network, wherein the certification method comprises at least:
identifying the resource;
generating a certification pack, which is uniquely associated with the resource, and one or more identification elements, which are uniquely associated with the certification pack; and
transmitting the one or more identification element associated with the certification pack to a distributed database;
wherein generating the certification pack comprises:
executing a procedure for acquiring the resource, the acquisition procedure comprising a series of steps;
at each single step of the acquisition procedure, interrogating a certification protocol in an iterative way;
at each interrogation, executing a corresponding certification procedure contained in the certification protocol and correspondingly generating one or more corresponding certification elements; and
generating a certification pack, and the one or more identification elements uniquely associated with the certification pack, from the group of the certification elements.
